(19) United States
(12) Patent Application Publication
(10) Pub. No.: US 2013/0044741 A1
(43) Pub. Date: Feb. 21, 2013

(54) Redirecting of data traffic between wan and lan

(71) Applicants: Antti Tuomas Lappeteläinen, Espoo (FI); Juha-Matti Tuupola, Tampere (FI); Timo Eriksson, Espoo (FI); Mikko Hurskainen, Helsinki (FI); Risto Suoranta, Tampere (FI); Antti Latva-Aho, Lempaala (FI); Pasi Katajainen, Tampere (FI)

(72) Inventors: Antti Tuomas Lappeteläinen, Espoo (FI); Juha-Matti Tuupola, Tampere (FI); Timo Eriksson, Espoo (FI); Mikko Hurskainen, Helsinki (FI); Risto Suoranta, Tampere (FI); Antti Latva-Aho, Lempaala (FI); Pasi Katajainen, Tampere (FI)

(73) Assignee: NOTAVA OY, ESPOO (FI)

(21) Appl. No.: 13/576,538

(22) PCT Filed: Dec. 22, 2010
(86) PCT No.: PCT/FI2010/051076

§ 371 Date: Oct. 19, 2012

(30) Foreign Application Priority Data
Feb. 12, 2010 (FI) 20100055

(51) Int. Cl. H04W 48/18; H04W 12/06

(52) U.S. Cl. 370/338

(57) ABSTRACT

A method and apparatus for redirecting data traffic, the method includes exchanging user data over a wireless connection with a destination identified by an Internet Protocol address using a wide area bearer, receiving, over the wide area bearer, an off-loading indication message including address information of at least one local access server, exchanging signalling messages including information regarding one or more available local access networks with the at least one local access server specified in the off-loading indication message, selecting a local access network based at least part on information exchanged with the at least one local access server and on information regarding wireless signal coverage activating a supplementary wireless local area bearer based at least part on information regarding one or more available local access networks received from the at least one local access server, and routing new connection opening requests to the supplementary wireless local area bearer.

### TECHNICAL FIELD

The present invention relates to redirecting of data traffic.

### BACKGROUND

Second generation (2G) and third generation (3G or 3.5G) wide area networks are widely spread all over the world and provide varying capabilities for mobile applications in terms of bandwidth, coverage and latency. Typically these mobile networks provide data rates that are generally adequate for services employing a low to medium bandwidth applications such as voice communications, text messaging, instant messaging, e-mail with no or relatively small attachments. The data access rates tend to be marginal for services, which demand or would otherwise benefit from a higher bandwidth such as multimedia streaming, rich content web browsing, or large file downloads. The greatest advantage of these networks is the wide area coverage except indoors. On the contrary wireless local area networks, WLANs based on IEEE 802.11 standard, offer far better data rates and are today extensively deployed especially in metropolitan areas. These networks also offer indoor coverage.

The capabilities of mobile devices are growing fast and more advanced devices are consuming more bandwidth in the networks they operate. These devices are equipped with both cellular connectivity and local area connectivity and applications such as web browsers and multimedia streaming applications. This requirement of bandwidth sets new challenges to cellular networks thus mechanisms to balance the load to local area networks with much greater bandwidth capacity would be desired. The local area networks provide high data rates needed to fulfill application and user needs but the knowledge of the congestion status of the wide area mobile networks is only available to the wide area network operator. The mobile station operating in the wide area network may be able to produce short-term knowledge of the data throughput of its own network interface but is not conscious about the network status. This means that the operator has the key position in making its mobile subscribers aware of the network congestion while the mobile clients could do any intelligent decisions based on that information independently.

Therefore there is a need for transferring information originated from either cellular networks or local area networks and reacting to that information to gain better network connectivity.

### SUMMARY

According to the first aspect of the invention, a method comprising exchanging user data over a wireless connection with a destination identified by an Internet Protocol address using a wide area bearer, receiving, over the wide area bearer, an off-loading indication message comprising address information of at least one local access server, exchanging signaling messages comprising information regarding one or more available local access networks with said at least one local access server specified in said off-loading indication message, selecting a local access network based at least part on information exchanged with said at least one local access server and on information regarding wireless signal coverage activating a supplementary wireless local area bearer based at least part on information regarding one or more available local access networks received from said at least one local access server, and routing new connection opening requests to said supplementary wireless local area bearer is provided. According to an embodiment of the first aspect of the invention, the method may further comprise routing an existing data exchange session via said supplementary wireless local area bearer.

According to an embodiment of the first aspect of the invention, the method may further comprise routing an existing data exchange session via said supplementary wireless local area bearer. Furthermore, the method according to the first aspect of the invention may further comprise detecting an event indicating closing of a connection using said supplementary wireless local area bearer; and rerouting an active data exchange session via the wide area bearer.

The preferred embodiments of the invention include at least a method, computer program, device and system for opening at least one Internet Protocol based wireless connection to a destination identified by a specified Internet Protocol address using a wide area bearer and receiving, over wide area bearer, an off-loading indication message containing address information of a local access server. A communication with this local access server may be later established using additional address information that may be provided with this indication message. In addition the address information may be constructed as a combination of the provided address information and locally stored static information, such as a security key.

The established communication session with the local access server may, in accordance with various configurations of the preferred embodiments of the invention, later include exchanging of messages providing further information about the identities of the available wireless local area networks within the vicinity of the receiver of the off-load indication message. On the other hand the available local area networks may not be known by the local access server but instead may be received as a part of the messages exchanged in this communication session. Further, the message exchange may include authentication information, security scheme, keys needed to establish connection to the available local area networks, or a specific expiry time for the network access.

In at least one embodiment of the present invention, the off-loading information may be sent using and received as at least one short message service (SMS) message. This message may contain further information about local access server and security data used later for authentication or ciphering.

In at least one embodiment of the present invention, the information received from a local access server may be used to adjust the metrics or alter other information related to network bearer selection process executed for example in the receiver. It may also contain a specific action proposal for the bearer selection process. The decision of choosing any bearer to be used in exchanging data, however, is made by the sole owner of the bearer resources. Further, the context information such as, physical speed, active applications, data download and upload profiles may have an impact on the decision.

According to an embodiment of the first aspect of the invention, the method may further comprise detecting an event indicating closing of a connection using said supplementary wireless local area bearer; and rerouting an active data exchange session via the wide area bearer. In at least one embodiment according to the first aspect of the present invention, a change in the bearer used for data exchange session may cause routing all priori opened data exchange sessions to use this new bearer. In accordance with preferred embodiments of the invention, said event indicating closing of a connection and/or routing all priori opened data exchange sessions to use the new bearer may be triggered by the network selection process, loss of network coverage, such as loss of coverage of said supplementary wireless local area bearer, expiry of usage time, such as expiry of usage time of said supplementary wireless local area bearer, or by receiving an action proposal or an action state within a further off-loading indication message.

According to the second aspect of the invention, an apparatus comprising a processor capable to execute program code and a suitable memory capable to store program code and data. According to the second aspect of the invention, the program code is configured, when executed by the processor, to cause the apparatus to detect a feasible internal state that allows usage of a local area communications interface as a supplementary bearer, exchange signaling messages comprising information regarding one or more available local access networks with said at least one local access server specified in said off-loading indication message, select a local access network based at least part on information exchanged with said at least one local access server and on information regarding wireless signal coverage, activate the local area communication interface based at least part on information regarding one or more available local access networks received from said at least one local access server, and route new connections over the local area communication interface.

### BRIEF DESCRIPTION OF THE DRAWINGS

FIG. 1 is a block diagram showing the elements of the wireless wide area and local area communication systems.

FIG. 2 is a block diagram of the overall system architecture and related interaction in accordance with preferred embodiments of the invention.

FIG. 3 is a flow diagram of a process for receiving network oriented information from a wide area network and a local area network in accordance with preferred embodiments of the invention.

FIG. 4 is a flow diagram of a process for facilitating supplementary bearer selection and data exchange session modification in accordance with preferred embodiments of the invention.

FIG. 5 is a flow diagram of a process for facilitating wide area bearer selection and data exchange session modification in accordance with preferred embodiments of the invention.

FIG. 6 is a block diagram of the exemplary mobile client internal functional architecture in accordance with the preferred embodiments of the invention.

FIG. 7 is a sequence diagram of the exemplary security process used between the client and the network side instances in accordance with preferred embodiments of the invention.

FIG. 8 is a block diagram of an exemplary implementation architecture of the mobile client in accordance with preferred embodiments of the invention.

FIG. 9 is a block diagram of an exemplary implementation architecture of the mobile client and the network side operational instances in accordance with preferred embodiments of the invention.

FIG. 10 is a flow diagram of a process for facilitating a client-originated position information transfer in accordance with preferred embodiments of the invention.

### DETAILED DESCRIPTION

For the purposes of explanation, numerous specific details are set forth in order to provide a thorough understanding of the embodiments of the invention. It is apparent, however, to one skilled in the art that the embodiments of the invention may be practiced without these specific details or with an equivalent arrangement.

As used herein, the term Client Manager (CM) refers to a physical component or set of physical components, e.g. computer hardware, networking infrastructure, and computer software, that provide the means for the wide area network operator to manage the network selection of its subscribers. As used herein, the term Network Manager (NM) refers to a physical component or set of physical components, e.g. computer hardware, networking infrastructure, and computer software, that provide the means for the local area network operator to manage the network selection, providing information about the network related details such as access credentials, and manage client authentication. Herein, the term Client (CL) includes, but is not limited to, a station, a mobile station, user equipment, or a mobile subscriber unit, or any other type of device capable of operating in wireless communication environments. Also, herein, the term WLAN refers to an IEEE 802.11 based wireless communication system and the term 3G refers to a Universal Mobile Telecommunications System (UMTS) wireless communication system.

The preferred embodiments of the invention facilitate methods for performing data off-load from one wireless communication system to another wireless communication system that likely use different communication protocols. The wireless communication systems may be any type of present or future developed wireless communication systems, but not limited to UMTS, High-Speed Packet Access (HSPA), Global System for Mobile Communications (GSM), General Packet Radio Services (GPRS), Code Division Multiple Access 2000 (CDMA2000), and IEEE 802.11 based WLAN systems.

For the purposes of explanation simplicity the example embodiments is described with reference to a 3G system and a WLAN communication system that provides a network, or a hot spot, within the coverage of 3G system. However, the preferred embodiments of the invention also apply to other wireless communication systems as well.

Operating Environment

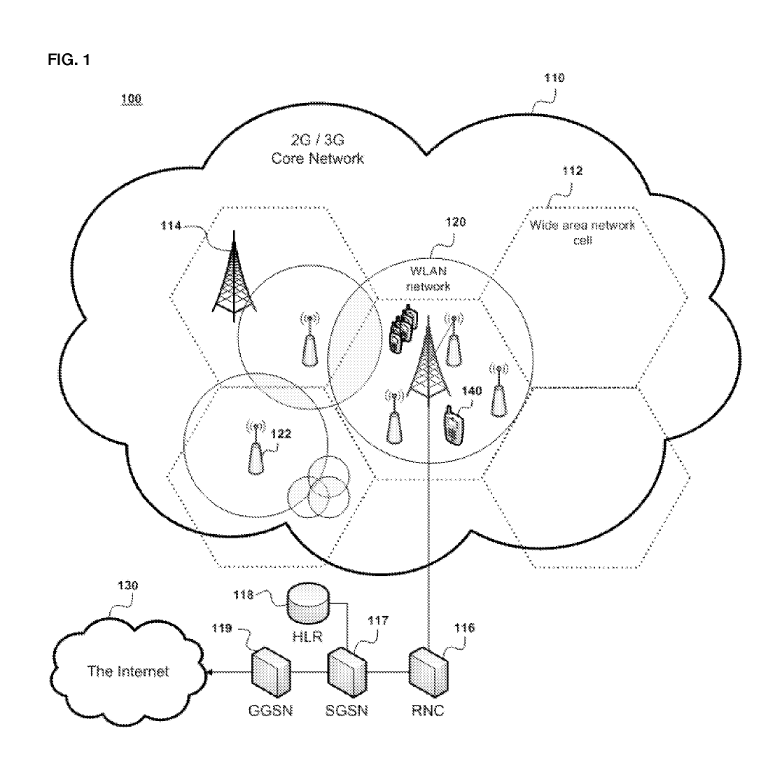

FIG. 1 is a wireless communication system 100 in accordance with at least one embodiment of the invention. The system 100 comprises of two communication systems having an overlapping coverage area and having two different communications protocols. FIG. 1 presents a 3G system 110 and a WLAN system 120 where the 3G system 110 has a wider coverage compared to the WLAN system 120 within the 3G coverage area. The 3G system 110 is composed of plurality of cells 112, each of which is served by a base station 114. Further, the 3G system 110 comprises network elements Radio Network Controller (RNC) 116, Serving GPRS Support Node (SGSN) 117, Home Location Register (HLR) 118, and Gateway GPRS Support Node (GGSN) 119 to connect to the Internet 130. The WLAN system 120 comprises access points (AP) 122 that serve the clients 140 using the WLAN system 120. FIG. 1 also presents the problem where base station 114 serving multiple clients 140 may result in congestion where the data throughput of clients 140 drops to an unacceptable level. In most cases the area covered by the cell 112 also has WLAN networks 120. The WLAN system 120 may be managed by the operator of the 3G system 110 or by some other operator of similar 3G or other wide area wireless system, or private individuals. Those skilled in art will recognize that the system 100 can be generalized to include more than two communications systems and an arbitrary number of communication protocols applying Internet protocol. Especially, an environment with a single communication protocol is possible such as two 3G or two WLAN communications protocols.

Furthermore, those skilled in art will recognize that the FIG. 1 do not depict all the necessary network devices and equipment necessary for system 100 to operate fully but only those system blocks and logical entities particularly relevant to the description of embodiments of the invention. Those skilled in art are aware of the many ways the necessary components can be implemented.

System Description

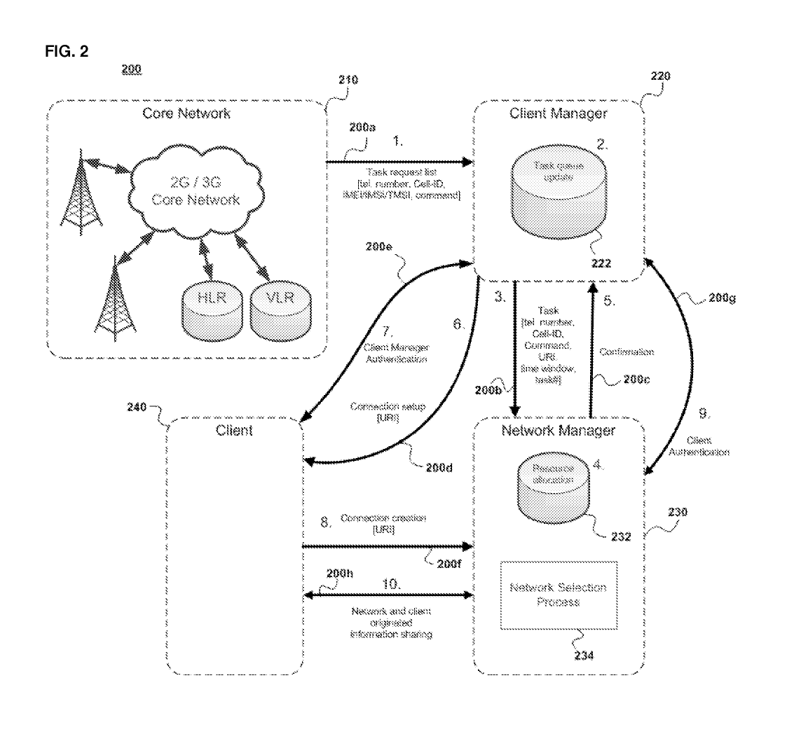

FIG. 2 discloses a system architecture 200 of the preferred embodiments of the invention. The architecture 200 comprise of four main elements of which a core network 210, presents the cellular network and its relevant components such as base station 114, RNC 116, SGSN 117, HLR 118, and GGSN 119. Client Manager 220 is the aforementioned system that provides the means for the core network 210 operators to manage the network selection of its subscribers. Network Manager 230 is the aforementioned system that provides means for the WLAN 120 operators to manage the network selection of the client 240, providing information about the network related details such as access credentials, and manage client 240 authentication. The FIG. 2 also presents high level messaging and information passing functions, with relevant phase, of the system 200.

FIG. 2 is explained hereafter according to at least one embodiment of the present invention. The scenario starts with the assumption that the 3G core network 210 is serving a growing amount of subscribers 240 that are consuming the data transfer capacity of the network 210 eventually leading in to a congestion situation where the network becomes overloaded. The bottle neck of the system performance may be for example the RNC 116, SGSN 117, or GGSN 118 or any other component or combination of components in the core network. The operator of such network could gain knowledge about the network congestion by gathering information about subscribers within each cell 112 and about the network itself. This information could be for example load in the network, base station 114 locations, data usage pattern, or user profiles. Based on this advanced knowledge the core network could implement hardware, software, or both that is able to put together a task list update request 200a to the Client Manager 220. The main function of the request is to identify potential subscribers within a specific cell 112 that would benefit from using possibly available WLAN network 120 instead of continue using 3G network 110 for data exchange in the Internet. Such task list update request 200a may contain information such as telephone number of the subscriber, cell-id of the 3G cell where it is currently operating, an International Mobile Equipment Identity (IMEI), an International Mobile Subscriber Identity (IMSI) and/or a Temporary Mobile Subscriber Identity (TMSI) code of the subscriber, and a 3 G operator preferred action state to be associated with the subscriber. The action state in the most simplest form may be a ‘ON’/‘OFF’ command string wherein the ‘OFF’ means that the network operator suggests that the subscriber should off-load from the 3G network and on the contrary ‘ON’ means that the network operator suggests that the subscriber should on-load back to 3G network. Here the term off-load refers to directing data traffic out from the 3G network to some other network and on-load refers to directing data traffic in to the 3G network form some other network.

The second entity in the system is a connection manager (CM) 220. The CM 220 could be for example a network server running in the Internet with capabilities to process task list update requests 200a from core network 210. Upon receiving a task list update request 200a the CM 220 will process the content of the request and update its internal data records 222. This processing may include assigning a unique task identifier for the received task and combining that with the information received in task list update request 200a. After the internal processing the CM 220 looks for relevant network manager (NM) 230 instances from its internal NM database where the measurement of relevance may be the location of the subscriber, 3G network load, or other statistics. This location may be derived from the cell id received in request 200a. After the selection the CM 220 creates an IP based connection to the NM 230 and sends a service request 200b to the NM 230 with all relevant client information included after which the NM 230 may allocate computing resources 232 for the given task. NM 230 may perform authentication for the CM 220 using for example a digital certificate. If the NM 230 is able and willing to allocate such resources it will confirm the service request back to CM 220. The availability of the allocated resources 232 may be limited to be valid only for a certain amount of time, accessed only using a specific URI provided in 200b, or the resource may be considered invalid if the first attempt to access the resource using the provided URI fails for any reason. If any such failure occurs, allocated resources 232 may be deallocated.

After NM 230 has finished with the resource allocation and related confirmation, CM 220 may send an SMS-message 200d to the defined CL 240 to set up a connection with the NM 230. Using a known digital certificate of the CM 220, CL 240 is able to authenticate the sender of the SMS 200d using a asymmetric public key infrastructure cryptography. In the SMS message 200d CM 220 may inform the CL 240 about the assigned NM 230 details, the given unique task identifier and the URI to which a new connection should be made. Using this information the CL 240 is able to establish a connection to the NM 230. Upon connection creation the CL 240 may send an authentication data to the NM 230, which then authenticates the CL 240 by bypassing the data to CM 220 and waits for a confirmation of the authentication. The authentication process instance in NM 230 authenticates mobile with the help of CM 220, keeps track on a time window that was priori set during a service request from CM 220, and also manage possible payment procedures. Following the authentication the NM 230 and CL 240 are able to exchange data 200h. In this exchange of data NM 230 provides CL 240 detailed instructions about the preferred list of available WLAN networks 120. The selection of preferred WLAN networks, or Service Set Identifiers (SSID) hereafter, is carried out in a network selection process 234 in the NM 230. The list of SSIDs may be based on geographical location derived from the 3G cell-id received in a task allocation request 200b, or the NM 230 may request the CL 240 to provide list of SSIDs within its vicinity. Further the NM 230 will provide the required WLAN network credentials, such as WPA/WPA2 security keys, to the CL 240 when such credential exists. Following the message passing between CL 240 and the NM 230 the connection is closed and NM 230 may free the resources allocated for the task.

Client Operations

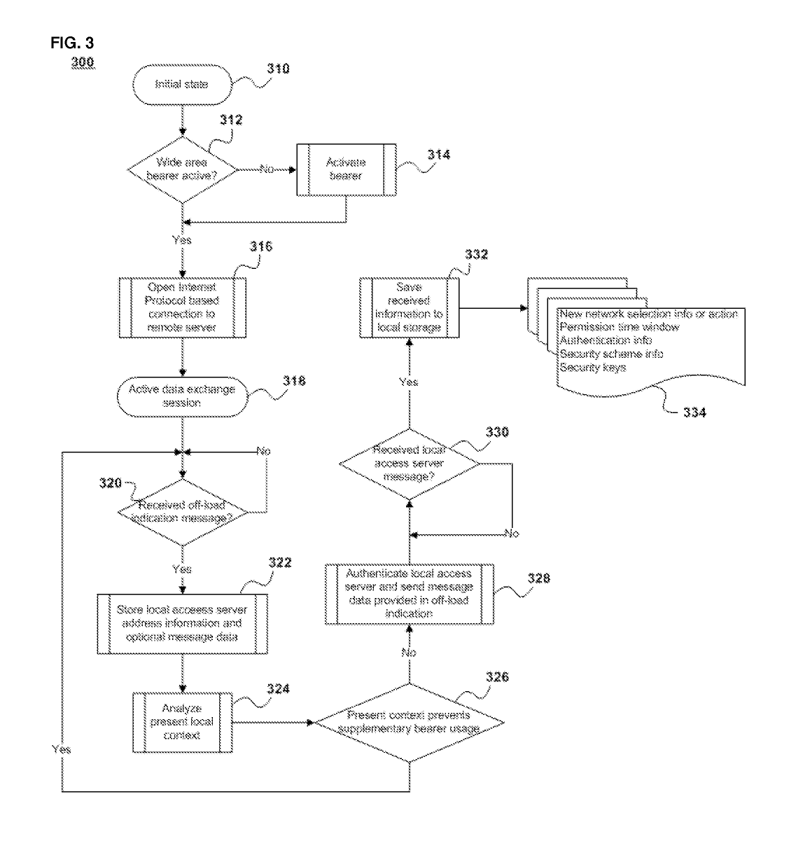

FIG. 3 discloses a flow diagram 300 of a process for receiving network-oriented information from a 3G system 110 and a WLAN system 120 in accordance with the first embodiment of the present invention. The process depicts the behavior of the client 140. The initial state 310 refers to any regular state of the client where the user of the client device is able to operate normally. To establish IP connectivity for being able to exchange data the client 140 should have at least one IP capable bearer active. In 3G system said bearer is a wide area bearer. If no bearer is active in step 312 then the wide area bearer is activated in 314 and IP connection to remote server for obtaining IP address and other network interface related parameters in step 316. State 318 refers to a state in client 140 where the client is able to send and receive data in IP network such as the Internet.

According to the preferred embodiments of the invention the client 240 may receive an off-load indication message from CM 220. If such message is received in step 320 the client process will store 322 any information received in the message such as a server address. After receiving the said off-load indication the client may analyze the present context in step 324. This may include analysis about the physical speed of the client device that would support usage of cellular connectivity 110 over WLAN connectivity 120 or even prevent the client from using WLAN communications. On the other hand currently active applications running in the client 240 may set such requirement that the WLAN communications would not satisfy. Furthermore the history data of the amount of downloaded or uploaded data in a recent time period may equally well indicate that only guaranteed outdoor coverage would be suitable for the client 240. If the context analysis indicates that the data offload from 3G network 110 to WLAN network 120 is impossible or may severely harm the operations of the client then the client may neglect the off-load indication information and continue operating as before receiving the said off-load indication.

If the conclusion in step 326 was not against off-load proposal a connection may be created to the server address, or URI composed of server address and a unique task identifier allocated by CM 220. This server is the NM 230. In this step 328 the client may reuse the digital certificate of the CM 220 that was pre-installed in the client 240 internal memory in the following manner. The client may encrypt its own IMEI, IMSI, or TMSI code using the public key of the certificate and send that as the first data to the NM 230. Similarly the client may use for example user account information of a web service to be encrypted for authentication purposes. NM 230 further passes the same data to the CM 220 as a part of a authentication message passing. Since the data was encrypted with the public key of the CM 220, it can verify the content and further verify that the sender of that information indeed is the one that was earlier advised to connect to the NM 230. If the authentication succeeds the operation continues in step 330, otherwise the client returns to normal operation state 318. In step 330, information about the availability of WLAN communications is exchanged between the client 240 and the NM 230. The communications may be in a form of XML structured information where the NM 230 provides a single, or a list of, SSID of the available WLAN network in the area where the client 240 is currently operating. If the NM 230 does not have information about any WLAN networks in the area it may ask the client 240 to scan for networks and send a report about those. In addition since in most cases the WLAN networks are secured using for example WEP, WPA, WPA2 or 802.1x security mechanisms the NM 230 supplies the necessary passwords to the client 240 for it to be able to associate to the said WLAN network. All this may be achieved by sending XML messages. All information received from NM 230 is stored locally in the client 240 in step 332 and is further used as a part of the decision-making process of the most suitable data bearer in any given time. The outcome of the process 300 is a set of details, rules, and other information about available networks stored locally in the client 240 memory depicted in step 334.

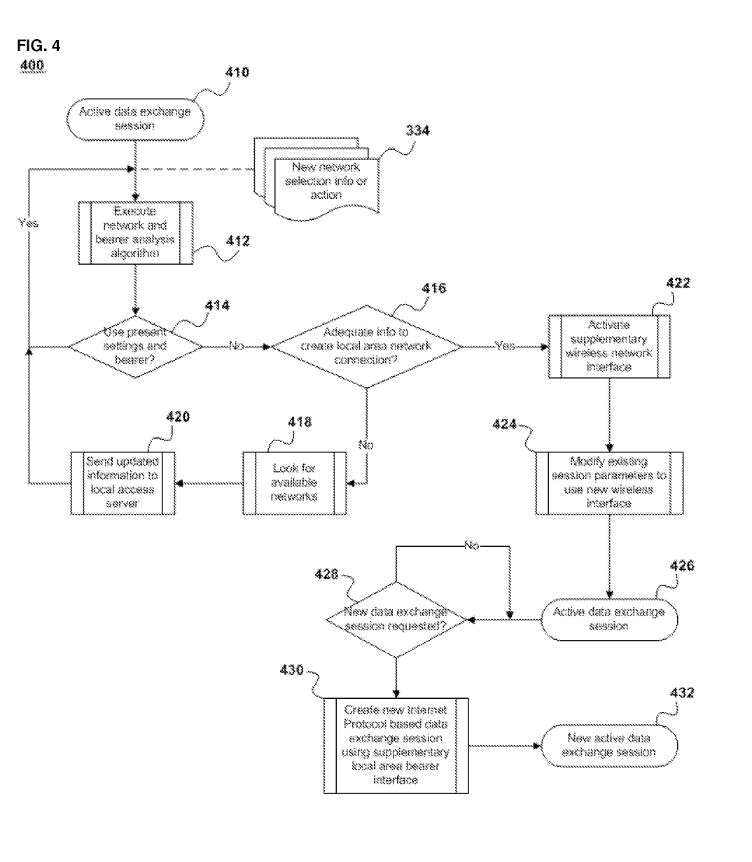

FIG. 4 is a flow diagram of a process for facilitating supplementary bearer selection and data exchange session modification in accordance with the second embodiment of the present invention. State 410 represents a connection state of the client 240 where an IP-based connection to the remote server has already been established using a 3G bearer and optionally some data has been exchanged. Network selection info 334 is the information or proposed action for bearer selection received outside the client 240 and the additions or updates to that information are unpredictable from the client perspective. The information 334 is stored to the client 240 memory such that is usable for the components responsible for the bearer selection. The information that is stored may be either client 240 originated or network originated 110, 120. According to at least one embodiment of the present invention, examples of such client originated information include contextual location (home, car, airplane, hospital, work, country) or movement status (walking, still, moving fast) that could be provided by an internal GPS module, motion sensor profile data or similar. Moreover the information could include noise information, peripheral connection status, sensing of the radio frequency transmissions (Bluetooth, FM radio, NFC, UWB etc.), activity of running applications in the client, power management status of the client, or for example the luminosity of the display of the client device. Examples of network-originated information include traffic load that can be pinpointed to geographical location, base station 114 or WLAN access point 122 locations, user profiles based on statistics of the client, operator subscriptions, or web service subscriptions.

Referring to FIG. 4, the analysis algorithm process 412 may be run periodically or it may be triggered by other means by the system. Despite the execution frequency and starting trigger the process 412 analyze all or parts of the aforementioned information provided to its visibility and in step 414 makes a decision to either propose use the current 3G connectivity settings or promoting the WLAN connectivity instead. If the WLAN connectivity is proposed the connectivity module verifies if any WLAN preferences are stored in the local memory in step 416 and if not so then performing a scan to retrieve information about the available WLAN networks within the vicinity of the client 240. After the scan operation said information is assembled in a form of a message that can be sent to the NM 230 and then continuing normal operation in state 410. If on the other hand WLAN information is available in step 416 then the client activates the WLAN interface if not already active in 422 and modifies the system internal data records such that all currently active IP-based data exchange sessions are updated according to the new WLAN based networking settings. After the said modifications of the present sessions the system is in state depicted in 426. Any forthcoming requests to open new connection to remote server are then based on the new settings i.e. using the WLAN interface for data traffic (428, 430).

According to an embodiment of the invention, activation of a supplementary wireless local area bearer, such as a bearer providing WLAN connectivity, comprises activating said supplementary wireless local area bearer only in case said supplementary wireless local area bearer provides improved performance over the currently employed wide area bearer, such as a bearer providing 3G connectivity. As an example, a supplementary wireless local area bearer may be activated only in case it provides a performance at least equal to the currently employed wide area bearer. As another example, a supplementary wireless local area bearer may be activated only in case it provides a performance that exceeds the performance of the currently employed wide area bearer by at least a predetermined margin. A performance evaluation may comprise consideration of one or more factors associated with the quality of service (QoS) metrics. As an example factors considered in a performance evaluation may comprise one or more of average, maximum or guaranteed data rate provided by a bearer, error rate provided by a bearer, one-way or round-trip transport time provided by a bearer, etc. Means for evaluating a performance of a bearer may comprise for example metrics derived based on transmission of actual user data over a bearer or transmission of probe data e.g. in a form of one or more ping messages.

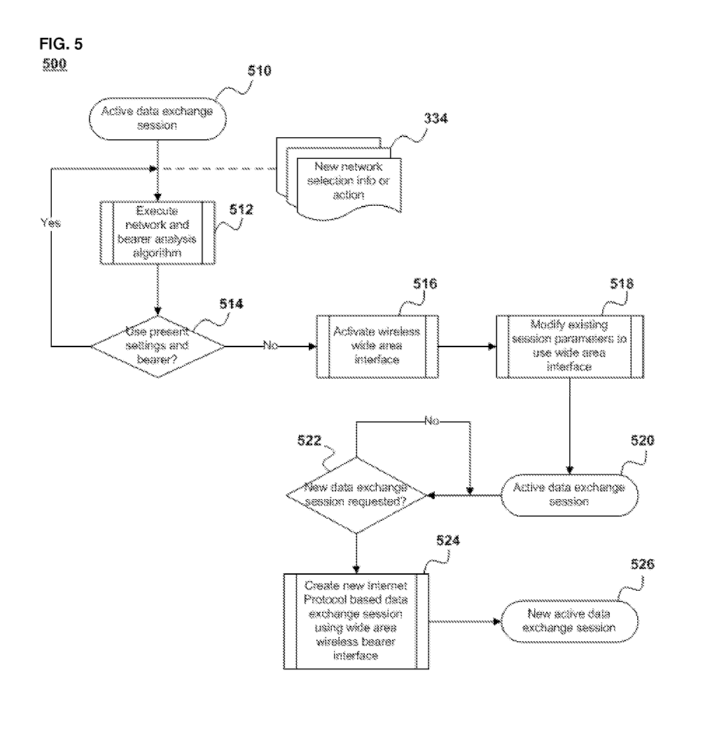

FIG. 5 is a flow diagram of a process for facilitating wide area bearer selection and data exchange session modification in accordance with the third embodiment of the present invention. The diagram depicts the similar kind of process as depicted in FIG. 4 but now in a situation where the client 240 is already using WLAN interface for IP-based data traffic but the updated network selection information 334 affects the algorithm 512 such that 3 G communications is promoted over WLAN communications.

According to an embodiment of the invention, an event indicating closing of a connection using a supplementary wireless local area bearer, such as WLAN, may be detected. The event that indicates closing of the connection may be based at least in part on for example one or more of loss of coverage of said supplementary wireless local area bearer, expiry of usage of said supplementary wireless local area bearer or receiving an action state within an off-loading indication message. Furthermore, closing of the connection may comprise routing one or more active data exchange sessions making use of the supplementary wireless local area bearer via a wide are bearer, such a 3 G communication network. An event indicating closing of a connection using a supplementary wireless local area bearer may further trigger deactivating an interface to the supplementary wireless local area bearer. In an embodiment of the invention, the deactivation of an interface to the supplementary wireless local area bearer takes place only in case the interface to the supplementary wireless local area bearer was activated as a result of off-loading a data session using a wide area bearer to the supplementary wireless local area bearer.

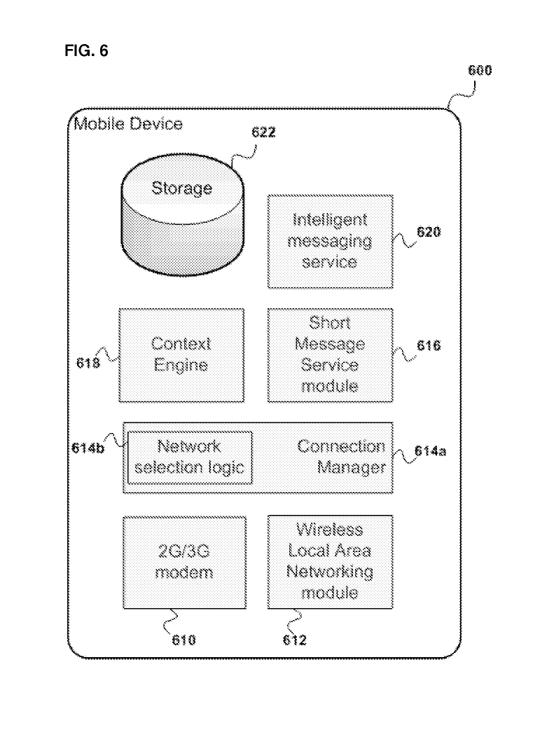

FIG. 6 discloses a block diagram of the mobile client internal functional architecture in accordance with the preferred embodiments of the invention. The aforementioned functionalities of the client 140 may be mapped to the blocks depicted as a part of device 600. 2G/3G modem 610 is a combination of relevant hardware and software components that enable the device 600 to operate in 3G systems 110. Similarly WLAN module 612 is a combination of hardware and software components enabling the operations in WLAN networks 120. The connection manager 614a may be purely software component of the system that implements the selection logic 614b that has different input sources such as connectivity settings, WLAN access point lists, context information and it controls the selection of IP connectivity of the device 600. Short message module 616 implements necessary functions that are required to receive and process the SMS-messages received using the modem 610. The context engine 618 is a software module responsible for analyzing the present context of the device 600 based on multitude of external inputs and sensor data. The output may serve many purposes in the device 600 and also interfaces with the connection manager 614a. The intelligent messaging service 620 is a software module performing message exchange with the NM 230. All the building blocks described may be connected together by a system bus that coordinates internal information passing of the device 600. One such system bus used between software components may be for example D-Bus.

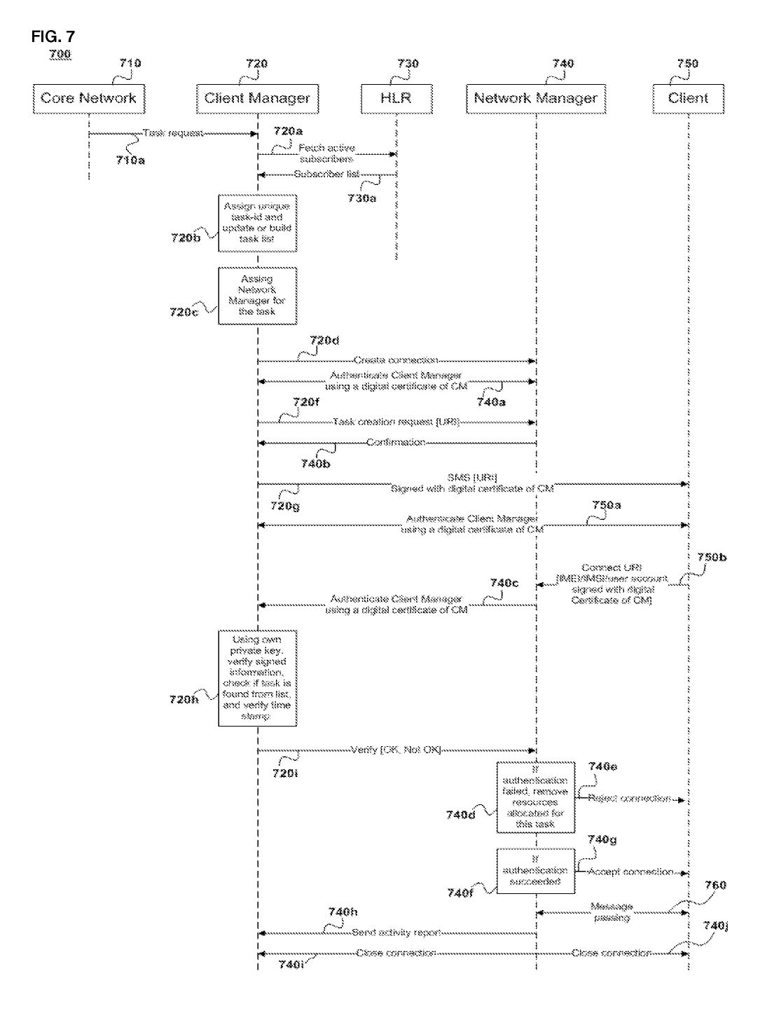

FIG. 7 is a sequence diagram of the exemplary security process used between the client and the network side instances in accordance with the preferred embodiments of the invention. The sequence begins with the perquisite task update request 710a originated from core network 710 or a off-load guidance request from client 750. This follows some kind of a subscriber list report originated from core network instances such as visitor location register or home location register 730. CM allocates unique task identifier 720b and creates a dedicated handler for the task and selects at least one NM to serve the said task. A connection between CM and selected NM is the created 720d where the initiator is the CM 720 and acceptor is the NM 740. The acceptor can authenticate the initiator using a pre-installed digital certificate of initiator and following the successful authentication CM 720 will request the NM 710 to allocate adequate resources for the soon to be served off-loading task. If positive confirmation is received in the CM 720 it sends the URI and a task identifier to the client 750. The client 710 then authenticates the sender using a pre-installed digital certificate and again, if successful, encrypts selected user information such as its IMEI/IMSI/TMSI or a service username with the public key uncoupled from the same digital certificate that was used to authenticate the CM 720. This encrypted information is provided upon creating an IP connection to the NM 740 addressed by the combination of the URI and task identifier provided in the previously received SMS message. Once the NM 740 accepts the connection request it passes the encrypted information to the CM 720 using the same connection, if still valid, that was created earlier by the CM 720. CM 720 then either confirms or rejects the identity of the client 710. The security feature may also include time window for the client 750 to NM 740 connection establishment and/or limited trials for the said connection establishment. If the identity was confirmed, the client 750 and NM 740 may continue exchanging data.

Example Implementation

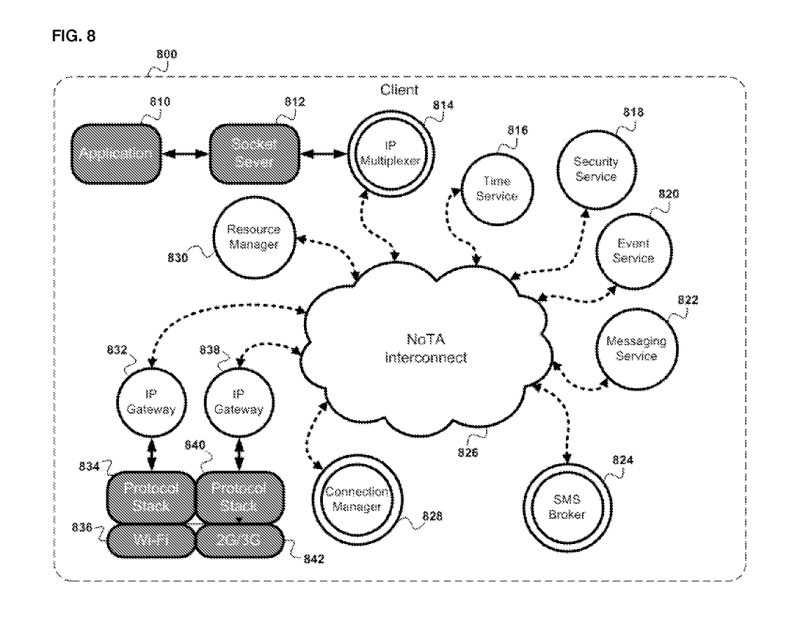

FIG. 8 discloses a block diagram of an example implementation of the client 140 described in the preferred embodiments of the invention based on Network on Terminal Architecture (NoTA). For simplicity only the assigned functionality of each element are described here leaving the details of implementation open. Application 810 is a user application that requires Internet connectivity. Socket server 820 is a software instance that is able to produce connection endpoints to which an application is able to interface and through which the application sends and receives data using one or more communication protocols. This instance is typically found in various operating systems such as Linux or Windows. IP Multiplexer 814 is a NoTA Application Node (AN) that use the services in the NoTA network to control the IP Gateways 832 and 838 i.e. makes a decision to switch the data transmissions between different IP-protocol stack instances and underlying transports. Resource Manager 830 is an AN that controls the usage of service nodes (SN) in the system. These service nodes are for example: Time Service 816 producing timing functions, Security Service 818 that provides means for Connection Manager AN 828 and IP Gateways 832 and 838 to gain knowledge about WLAN network security, Event Service 820 that produce system wide events to various ANs and SNs, and Messaging Service that provide the system for means to exchange XML messages between each node connected to the NoTA interconnect. SMS Broker AN 824 is responsible for receiving SMS messages and passing provided information through Messaging Service to rest of the system for further processing. IP Gateway SNs 832 and 838 provides socket interface to the IP protocol stack with selected transport for example Wi-Fi or 3G packet connection. IP Gateway is able to report its interface status and related information to the rest of the system. Connection Manager 828 is the intelligent component that controls the behavior of IP Multiplexer using collected information, policies and rules to make a choice for the optimal IP Gateway usage for any given time.

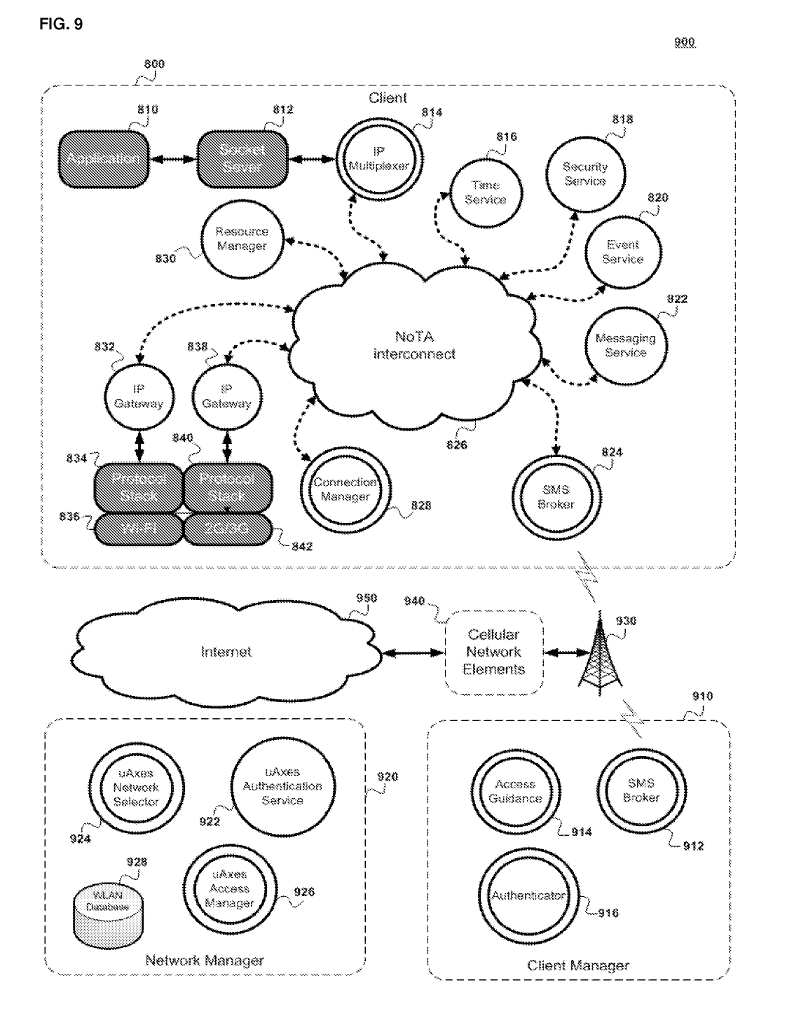

FIG. 9 disclose a block diagram of an example implementation of the system 200 based on Network on Terminal Architecture (NoTA).

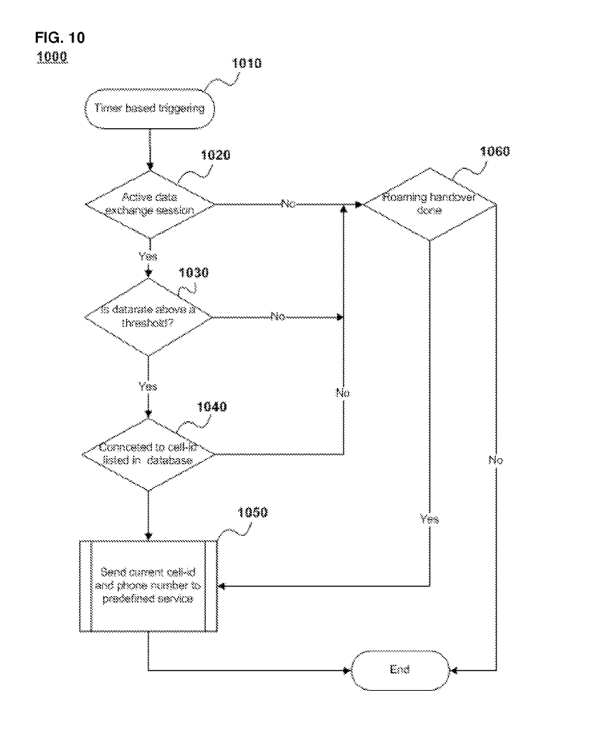

FIG. 10 discloses an advanced embodiment of the client operations. In this advanced embodiment the client executes the procedure described in flow chart 1000 concurrently to the operations described earlier. The procedure is triggered by timer 1010. During each timer interval the procedure may result in the sending of current cell-id and own telephone number to a predefined service, as illustrated in 1050. The sending procedure is triggered if all three decisions 1020, 1030 and 1040 are TRUE or if decision 1060 is TRUE. In 1020 the client determines whether it there is active on-going data session. In 1030 the client determines whether the averaged bit rate of the active on-going data session increased over a predefined threshold. In 1050 the client determines whether it is served through a cell-id pre-listed in its database. In 1060 the client determines whether it has roamed to network operated by another operator compared to the situation when the procedure was last executed. As an example, the procedure 1000 results in that all WLAN enabled smartphones subscribed to a specific operator company update their position in every five minutes if they have downloaded more than 1 MB of data during the last 5 minutes and they are in the most crowded area where this company is operating or alternative the smartphone is roaming in a foreign network. The procedure allows the operator to identify congestion only by area, where for example the area is identified by a cell ID, and it allows the operator to serve its customers with reduced roaming fees.

Although the features and elements of the present invention are described in the previous embodiments in a specific combinations, each feature or element can be used alone without the other features or elements of the embodiments or in a various combinations with or without the other features or elements of the present invention.

The following numbered clauses describe some embodiments of the invention.

Clause 1. A method comprising opening at least one IP based wireless connection to a destination identified by a specified Internet Protocol address using a wide area bearer; receiving, over wide area bearer, an off-loading indication message containing address information of at least one local access server, exchanging messages with at least one local access server specified in said off-loading indication message, selecting one local access network based at least partly on information exchanged with said local access server and wireless signal coverage, activating a supplementary wireless local area bearer using network selection information received from said local access server, routing new connection opening requests to said supplementary local area bearer, detecting an event indicating the closing of logical connections using the supplementary bearer, and rerouting all active data exchange sessions via said wide area bearer.

Clause 2. The method as described in clause 1, further comprising a routing a priori opened data exchange sessions via the supplementary local bearer.

Clause 3. The method as described in clause 1, further comprising receiving authentication information from local access server.

Clause 4. The method as described in clause 3, wherein the authentication information include security scheme to be applied and secure keys.

Clause 5. The method as described in clause 1, wherein the off-loading indication message is received as at least one short-message-service message.

Clause 6. The method as described in clause 1, further comprising detecting feasible internal state for using a local area network as supplementary bearer based on is at least partly on speed, amount of active applications, amount of downloaded data in a recent time period or amount of uploaded data in a recent time period.

Clause 7. The method as described in clause 1, wherein identification method of the wireless local area network is service set identifier (SSID).

Clause 8. The method as described in clause 1, wherein event indicating the closing of logical connection is triggered at least partly based on loss of coverage, expiry of usage of the supplementary bearer or receiving an action state within the off-loading indication.

Clause 9. The method as described in clause 1, wherein the full address of the local access server is obtained by combining information received in the off-loading indication message and static internal information.

Clause 10. The method as described in clause 1, further comprising sending the information of available local area networks to the local access server before receiving local area network selection information.

Clause 11. The method as described in clause 1, further comprising comparing own data transmission and serving cell-ID to stored values; and depending on the comparison result sending position and telephone number information to a predefined location.

Clause 12. The method as described in clause 1, wherein routing is performed by adjusting the metric values of the interfaces of the bearers.

Clause 13. The method as described in clause 12, wherein the values used for adjusting are at least partly received from the said wide area network.

Clause 14. The method as described in clause 12, wherein the decision of executing any routing changes with the data exchange sessions is done by the receiver of the off-loading indication message.

Clause 15. The method as described in clause 14 or claim 2, wherein routing is performed by disabling routes on other interfaces than interface of the bearer desired to be used.

Clause 16. The method as described in clause 1, claim 2, claim 12 or claim 13, wherein routing is performed by using firewall rules to hard-limit the network interface of the bearer to be used.

Clause 17. An apparatus comprising, a processor capable to execute program code, a suitable memory capable to store code and data, a wide area communication interface capable to open and utilize IP based wireless connections, a local area communication interface capable to open and utilize IP wireless connections, a virtual communication interface to receive an off-loading indication message containing address information of at least one local access server, program code configured to detect feasible internal state that allows usage of a local area communications interface as supplementary bearer, program code configured to exchange messages with at local access server specified in said off-loading indication message, program code configured to select local access network based at least partly on information exchanged with said local access server and wireless signal coverage and activating the local area communication interface using the network selection information received from said local access server, program code configured to route new connections over the local area communication interface, and program code configured to detecting an event indicating the closing of logical connections using the local area communication interface and to reroute all active data exchange sessions over the wide area communications bearer.

Clause 18. The apparatus as described in clause 17, wherein a priori opened data exchange sessions are rerouted over the local area communications interface.

Clause 19. The apparatus as described in clause 17, further comprising receiving authentication information from the local access server.

Clause 20. The apparatus as described in clause 19, wherein the authentication information includes security scheme to be applied and secure keys.

Clause 21. The apparatus as described in clause 17, wherein the virtual communications interface is short-message-service (SMS) Application Programming Interface (API).

Clause 22. The apparatus as described in clause 17, wherein the feasible internal state for using a local area communications interface to establish the supplementary bearer is at least partly depended on speed, active applications, amount of downloaded data in a recent time period or amount of uploaded data in a recent time period.

Clause 23. The apparatus as described in clause 17, wherein identification method of the wireless local area network is service set identifier (SSID)

Clause 24. The apparatus as described in clause 17, wherein event indicating the closing of logical connection is triggered at least partly based on loss of coverage, expiry of usage of the supplementary bearer or receiving an action state within the off-loading indication.

Clause 25. The apparatus as described in clause 17, wherein the full address of the local access server is obtained by combining information received in the off-loading indication message and static internal information.

Clause 26. The apparatus as described in clause 17, further comprising sending the information of available local area networks to the local access server through the wide area communications interface before receiving local area network selection information.

Clause 27. The apparatus as described in clause 17, further comprising comparing own data transmission and serving cell-ID to stored values; and depending on the comparison result sending position and telephone number information to a predefined location.

1-27. (canceled)

28. A method comprising:
exchanging user data over a wireless connection with a destination identified by an Internet Protocol address using a wide area bearer;
receiving, over the wide area bearer, an off-loading indication message comprising address information of at least one local access server;
exchanging one or more signaling messages with at least one of said at least one local access server, the exchange of one or more signaling messages comprising receiving information regarding one or more available local access networks, wherein said information regarding an available local access network comprises a network identifier and an indication of used authentication scheme;
selecting a local access network based at least in part on the network identifier received from said at least one local access server and on information regarding wireless signal coverage; activating a supplementary wireless local area bearer for exchanging user data using the selected local access network based at least in part on the indication of used authentication scheme received from said at least one local access server; and
routing new connection opening requests to said supplementary wireless local area bearer.

29. The method of claim 28, further comprising routing an existing data exchange session via said supplementary wireless local area bearer.

30. The method of claim 28, wherein said information regarding an available local access network further comprises authentication credentials associated with said used authentication scheme.

31. The method of claim 28, wherein the off-loading indication message comprises at least one short-message-service (SMS) message.

32. The method of claim 28, further comprising, upon receiving said off-loading indication message, detecting a feasible internal state for using a local area bearer as a supplementary wireless local area bearer based at least in part on one or more of speed, amount of active applications, amount of downloaded data in a recent time period and amount of uploaded data in a recent time period.

33. The method of claim 28, wherein exchanging one or more signaling messages comprises providing the information of one or more available local area networks to said at least one local access server before receiving said information regarding one or more available local access networks.

34. The method of claim 28, further comprising comparing, at a client device, an averaged bit-rate of exchanged user data to a threshold value and comparing the current serving cell-ID to a stored cell-ID value; and in response to the comparison sending information regarding the current position and/or the telephone number of the client device to a network element providing a predefined service.

35. The method of claim 28, wherein routing is performed by adjusting the metric values indicating performance of the interfaces of the wide area bearer and the local area bearer such that the user data is routed to the bearer desired to be used.

36. The method of claim 35, wherein the values used for adjusting are at least partly received over the wide area bearer.

37. The method of claim 28, wherein the decision of executing any routing changes of the data exchange sessions is performed by the entity receiving the off-loading indication message.

38. The method of claim 28, wherein activating a supplementary wireless local area bearer comprises activating said supplementary wireless local area bearer only in case said supplementary wireless local area bearer provides improved performance over the wide area bearer.

39. The method of claim 28, further comprising detecting an event indicating closing of a connection using said supplementary wireless local area bearer; and rerouting an active data exchange session via the wide area bearer.

40. The method of claim 39, wherein said event indicating closing of a connection is triggered based at least in part on loss of coverage of said supplementary wireless local area bearer, expiry of usage of said supplementary wireless local area bearer or receiving an action state within a further off-loading indication message.

41. The method of claim 28, further comprising deactivating an interface to the supplementary wireless local area bearer.

42. An apparatus comprising:
a processor capable of executing program code;
a memory capable of storing program code and data;
wherein the program code is configured, when executed by the processor, to cause the apparatus to
receive, over a virtual communication interface, an off-loading indication message comprising address information of at least one local access server;
exchange one or more signaling messages with at least one of said at least one local access server, the exchange of one or more signaling messages comprising receiving information regarding one or more available local access networks, wherein said information regarding an available local access network comprises a network identifier and an indication of used authentication scheme;
select a local access network based at least in part on the network identifier received from said at least one local access server and on information regarding wireless signal coverage activate the local area communication interface for exchanging user data using the selected local access network based at least in part on the indication of used authentication scheme received from said at least one local access server; and
route new connections over the local area communication interface.

43. The apparatus of claim 42, wherein the program code is further configured, when executed by the processor, to cause the apparatus to reroute an existing data exchange session over the local area communications interface.

44. The apparatus of claim 42, wherein said information regarding an available local access network further comprises authentication credentials associated with said used authentication scheme.

45. The apparatus of claim 42, wherein the virtual communication interface is a short-message-service (SMS) Application Programming Interface (API).

46. The apparatus of claim 42, wherein the program code is further configured, when executed by the processor, to detect a feasible internal state that allows usage of a local area communications interface as a supplementary bearer, wherein detecting the feasible internal state is at least partly dependent on one or more of speed, active applications, amount of downloaded data in a recent time period or amount of uploaded data in a recent time period.
